(19) United States
(12) Patent Application Publication
(10) Pub. No.: US 2016/0211130 A1
(43) Pub. Date: Jul. 21, 2016

(54) ELECTRODE FOR A SHORT-ARC HIGH PRESSURE LAMP

(71) Applicant: PHILIPS LIGHTING HOLDING B.V., Eindhoven (NL)

(72) Inventor: Olga Borisovna MINAYEVA, Eindhoven (NL)

(21) Appl. No.: 15/025,269

(22) PCT Filed: Sep. 12, 2014
(86) PCT No.: PCT/IB2014/064453

§ 371 Date: Mar. 26, 2016

Related U.S. Application Data
(60) Provisional application No. 61/883,259, filed on Sep. 27, 2013.

(51) Int. Cl. H01J 61/073; H01J 61/86

(52) U.S. Cl. CPC H01J 61/0737; H01J 61/0732; H01J 61/86

(57) ABSTRACT

An electrode for a short-arc high-pressure discharge device is disclosed. The electrode includes a body made from a thoriated tungsten material. The body forms a tip at one end. A coating layer covers a part of the thoriated tungsten material so that an area around the tip is not covered by the coating layer.

The present invention relates to an electrode for a short-arc lamp, in particular, to a tungsten coated cathode with a barrier layer for short-arc high-pressure lamps.

Conventional, short-arc lamps are a type of gas discharge lamp that produce electric light by passing electricity through ionized gas (e.g., xenon (Xe) or mercury vapor) at high pressure. The bright white light produced closely mimics natural sunlight. Xenon arc lamps, for example, are used in movie projectors in theaters, in searchlights, and for specialized uses in industry and research to simulate sunlight.

An arc region between anodes and cathodes of the short-arc lamps is so small that for many purposes, the short-arc lamps are effectively point sources. The anodes and the cathodes are generally made of tungsten. The cathode is small and pointed to ensure that the tip reaches a high temperature for efficient electron emission. The anode is more massive to withstand the electron bombardment and efficiently dissipate the heat produced.

In short-arc high pressure Xe lamps, the cathodes are generally made from a thoriated tungsten material. The thoriated tungsten material has exceptional characteristics (highest melting temperature of all oxides, Tₘₑₗₜ=3390° C., and low work function φ=2.5 eV) that make it ideal as an emissive dopant in such short-arc high pressure Xe lamps. However, one disadvantage of using thoriated tungsten is that it is a radioactive material that emits a-particles. The radioactivity is measured in Becquerel (disintegration per seconds). The Bq can be calculated as:

$$Bq = \frac{m}{{m}_{a }} {N}_{A} \frac{ln ( 2 )}{{t}_{1 / 2}}$$

where m is the mass of an isotope with atomic mass mₐ (in g/mol), N_{A} is an Avogadro number, and t_{1/2} is a half-life for a given isotope. T_{1/2} can be further defined as

$${t}_{1 / 2} = \frac{ln ( 2 )}{λ} ,$$

where λ is a positive number called the decay constant of the decaying substance (Th in this case). One conventional approach to reducing the radioactivity of the cathode is by reducing the mass of radioactive isotope in the sample. This approach is disclosed in U.S. Pat. Nos. 3,902,090 and 5,627,430 and US patent application 2010/0039035A1.

By using thoriated inserts near the tip of the cathode (core cathode approach) as in the conventional method noted above, the total mass of Th per cathode is reduced which also reduces the Bq value. However, such conventional methods also limit the amount of Th available to diffuse to the cathode tip which lowers cathode work function. This also means that the lifetime of the core cathode lamps may be reduced, especially for shorter-arc gap higher power operating conditions.

Accordingly, a need exists in the art for devices to address the shortcomings of the conventional electrodes described above.

One aspect of the present invention is applying a barrier layer to the sides of the cathode to reduce the alpha radiation emitted by Th. The effective reduction of Bq is done by reducing the decay constant A, while keeping the total amount of Th the same. This has the effect of keeping the lifetime of the short-arc lamps unchanged while reducing the emitted radiation.

One embodiment of the present invention is directed to a discharge lamp including an anode and a cathode. The cathode includes a thoriated tungsten material and a layer covering a part of the thoriated tungsten material. A tip area of the cathode is not covered by the layer.

In another embodiment of the present invention is directed to an electrode for a discharge device including a body made from at least a thoriated tungsten material.

The body forms a tip at one end. A coating layer covers a part of the thoriated tungsten material so that an area around the tip is not covered by the layer.

Another preferred embodiment of the present invention, the layer has a thickness in the range of 70 to 130 um.

In general, the various aspects and embodiments of the present invention may be combined and coupled in any way possible within the scope of the invention. The subject matter that is regarded as the invention is particularly pointed out and distinctly claimed in the claims at the conclusion of the specification.

The foregoing and other features and advantages of the invention will be apparent from the following detailed description taken in conjunction with the accompanying drawings.

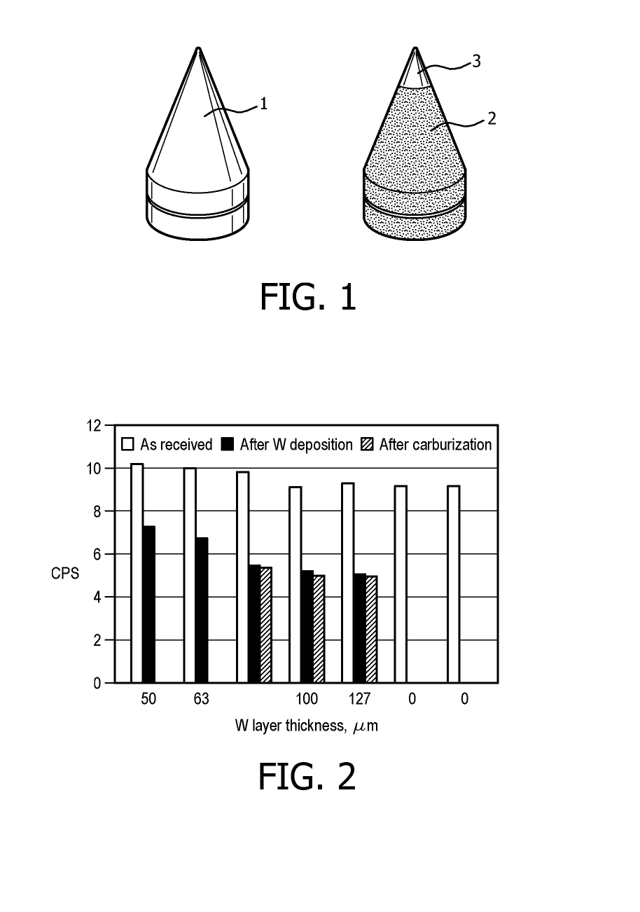

FIG. 1 shows a thoriated cathode 1 with and without a coating layer 2.

FIG. 2 shows a chart depicting the reduction in the decay constant in relation to the thickness of the coating layer 2.

As shown in FIG. 1, the thoriated cathode 1 is depicted without (left) and with (right) the layer 2. A tip area 3 of the thoriated cathode 1 is free of the layer 2. In a preferred embodiment, the thoriated cathode 1 is used in short-arc high-pressure Xe lamps. The tip area 3 of the thoriated cathode 1 should be 2-5 mm below the tip. This will allow for sufficient diffusion of Th to the tip operation.

In one embodiment, the layer 2 may be tungsten (i.e., a W layer). In other embodiments, the layer 2 may be another metal with high melting point. In this regard, a refractory metal may be used. Such metals have the high melting point (generally a melting point above 4,000° F. (2,200° C.)). The refractory metals include niobium, molybdenum, tantalum and rhenium. But other metals with melting points above 2,123 K (1,850° C.) may also be possible. Such metals include titanium, vanadium, chromium, zirconium, hafnium, ruthenium, osmium and iridium.

On top of the layer 2, tungsten carbide may be also applied using carburization. Such an additional carbide layer assists reduction of ThO₂ to form Th metal, which could diffuse easier to the tip of the cathode 1. Carburization involves a heat treatment of the side surface using a source of carbon. Carburization implants carbon atoms into the surface layers of a metal. Since the metal is made up of atoms bound tightly into a metallic crystalline lattice, the implanted carbon atoms force their way into the crystal structure of the metal and either remain in solution. This can be dissolved within the metal crystalline matrix (at lower temperatures) or react with the host metal to form ceramic carbides (at higher temperatures).

Different methods may be used to adhere the layer 2. For example, one or more of the following methods may be used to apply or deposit the layer 2: chemical vapor deposition (CVD), physical vapor deposition (PVD), plasma-enhanced chemical vapor deposition (PECVD), plasma spray or sintering.

In another embodiment of the present invention, the sides of the thoriated cathode 1 are roughened for better adhesion of the layer 2. The sides to be coated may be roughened by a grid blasting method or other conventional means. The increase in surface roughness has an additional benefit of improving the effective emissivity of the thoriated cathode 1. For this reason, increasing the surface roughness it is often used for the anodes of short-arc high-pressure Xe lamps, where the main cooling mechanisms are heat radiation and conduction.

In a preferred embodiment, a thickness of the layer 2 deposited layer is 75 um or more. A range of 75 to 130 um achieves greater reduction in the decay constant as shown in FIG. 2. A reduction in CPS (counts per second) of 40%-50% is achieved for deposited W layers of 75 um or more. Thicknesses above 130 um do not have significant effect on further reduction of the a-emission

In another embodiment, an additional layer of W carbide can formed on the layer 2. The preferred thickness of the additional carbide layer is 25-100 um. The tip area 3 of the thoriated cathode 1 is free of the additional layer. The tip area 3 free of the additional layer should be 1-2 mm below the tip to prevent from premature melting of the thoriated cathode tip. The additional carbide layer helps reduce thoria into Th metal and facilitate the emitter transport to the tip of the thoriated cathode 1. However, even though the thickness of the additional carbide layer is comparable to the layer 2 thickness, the reduction in radioactivity for the additional carbide layer is not as significant as it was for the W layer (as shown in FIG. 2).

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components, the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

1. A discharge lamp comprising:
an anode; and
a cathode,
wherein said cathode includes a thoriated tungsten material and said cathode having a layer covering a part of the thoriated tungsten material, and
wherein a tip area of said cathode is not covered by the layer and wherein the layer has a thickness in the range of 70 to 130 um.

2. The discharge lamp according to claim 1, wherein the layer is tungsten.

3. The discharge lamp according to claim 2, wherein said cathode includes an additional carbide layer over the layer.

4. The discharge lamp according to claim 1, wherein the layer is a metal with a high melting point.

5. (canceled)

6. (canceled)

7. The discharge lamp according to claim 1, wherein the tip area covers an area at least 2 mm below a tip of said cathode.

8. The discharge lamp according to claim 1, wherein the tip area covers an area starting 2-5 mm below a tip of said cathode.

9. The discharge lamp according to claim 1, wherein the discharge device is a short-arc high-pressure lamp.

10-15. (canceled)
